(19) United States
(12) Patent Application Publication
(10) Pub. No.: US 2008/0301022 A1
(43) Pub. Date: Dec. 4, 2008

(54) Real-Time Core Integration Method and System

(75) Inventors: Amit R. Patel, Woodbridge, NJ (US); Song Ting Ceng, Brooklyn, NY (US); Girish Narang, Mineola, NY (US)

Correspondence Address: COURTNEY STANIFORD & GREGORY LLP, P.O. BOX 9686, SAN JOSE, CA, 95157, US

(73) Assignee: CASHEDGE, INC., New York, NY (US)

(21) Appl. No.: 12/111,012

(22) Filed: Apr. 28, 2008

Related U.S. Application Data
(60) Provisional application No. 60/926,908, filed on Apr. 30, 2007.
(60) Provisional application No. 60/937,748, filed on Jun. 28, 2007.

(51) Int. Cl. G06Q 40/00

(52) U.S. Cl. 705/35

(57) ABSTRACT

Embodiments include a system, or platform, and method allowing financial institutions (FIs) to have access to an account opening platform that is capable of completing every aspect of the account opening approval process for the FI, and that is also capable of interfacing with their respective core systems (regardless of type or protocol) for receiving account opening requests from customers. Account opening requests may encounter permanent or temporary errors. When temporary errors are encountered, the account opening request is placed in a queue and automatically retried until the error is resolved. The account opening platform performs real-time integration with a variety of core systems such that approved new accounts are immediately “boarded” to the FI's core. In an embodiment, the platform is a plug-and-play” architecture such that adding the ability to communicate with new or different cores requires minimal effort. For example, no recoding of basic FMS software is required, but only coding of a plug-in module for a specific FI.

### RELATED APPLICATIONS

This application claims the benefit of U.S. Provisional Patent Application Ser. No. 60/926,908, filed Apr. 30, 2007, and further claims the benefit of 60/937,748, filed Jun. 28, 2007, both of which are incorporated herein by reference in their entirety.

### TECHNICAL FIELD

The invention is in the field of electronic financial account opening systems and methods.

### BACKGROUND

Currently there are various systems and methods for opening new financial accounts at financial institutions (FIs). Traditionally, customers or prospective customers visited an FI in person, and filled out paperwork. Often the account could not be opened until information was verified or further information supplied by the customer. Now there are faster ways of opening accounts, including methods of opening accounts via the Internet. In any case (online account opening or offline account opening), FIs employ “host” or “core” systems that function as account opening systems and maintain customer and account data, including new account information (account number assignment for example). Typically these cores are “black box” solutions that are built or purchased by FIs. An example is the MISER suite of software applications available from Fidelity. MISER is built around a single, integrated database containing customer, account, and financial information, with open connectivity to ancillary systems through extensible markup language (XML) and application programming interfaces (APIs). MISER is available from Fidelity, as is IMPACS, another cores system. Other examples of core systems include VISIONS AND CBS (available from FiServ), and HOGAN (available from CSC Industries).

One disadvantage of current core systems and methods of account opening is that when the account opening process cannot be completed for some reason (e.g., an account opening “milestone” has not been met) the customer's application is in effect rejected. The application is then essentially “thrown out” until an employee of the FI manually attends to any issues that caused the milestones not to be met, and then the account opening process can be restarted.

It would be desirable for FIs to have access to an account opening platform that is capable of completing every aspect of the account opening approval process for the FI, and that is also capable of interfacing with their respective core systems (regardless of type or protocol) for receiving account opening requests from customers. It would further be desirable for such an account opening platform to perform real-time integration with a variety of core systems such that approved new accounts are immediately “boarded” to the FI's core. It would also be advantageous for such a platform to be a “plug-and-play” architecture such that adding the ability to communicate with new or different cores requires minimal effort. It would also be advantageous for the account opening platform to communicate directly with the prospective customer and place applications that are not approved into a queue such that the application can be completed at any time by direct actions of the customer (e.g., by the customer satisfying a request for further information) or by the client's staff.

### BRIEF DESCRIPTION OF THE DRAWINGS

FIG. 1 is a block diagram of a financial system according to an embodiment.

FIG. 1A is a block diagram of a real time core (RTC) integration module of an embodiment.

FIG. 2 is a flow diagram of an online account opening process according to an embodiment including real-time core integration.

FIG. 3 is a diagram illustrating an account opening request flow according to an embodiment.

FIG. 4 is a flow diagram illustrating an automated account opening application flow according to an embodiment.

FIG. 5 is a flow diagram illustrating a manual account opening application flow according to an embodiment.

FIG. 6 is a flow diagram illustrating an instantaneous account opening application flow according to an embodiment.

FIG. 7 is a flow diagram illustrating an offline “open account” cron process flow according to an embodiment.

FIG. 8 is a flow diagram illustrating an account opening request queue management process according to an embodiment.

FIG. 9 is a diagram illustrating a funds transfer flow as conducted by an FMS funds transfer module 108 (see FIG. 1) according to an embodiment.

### DETAILED DESCRIPTION

Embodiments of the invention described and claimed herein are a Real-time Core Integration aspect of an Online Account Opening service (for example for financial accounts such as checking accounts at financial institutions (also referred to herein as FIs)). Real-time Core Integration includes the capability to use customer (or applicant) data to open account(s) for customers directly, and in real-time, at the Client's Core (also referred to herein as a host, or servicing data processing vendor (DPV)). As used herein, the terms “applicant” and “customer” are interchangeable. As used herein, a Client includes a financial institution at which the customer opens an account using an Online Account Opening service. Because no two FIs are exactly the same, a certain level of customization is expected for each FI, especially in the area of the data and data format. In various embodiments a financial management system (FMS) provides Real-time Core Integration as an aspect of an Online Account Opening service provided to clients, including FIs.

Embodiments include a system, or platform, and method allowing FIs to have access to an account opening platform that is capable of completing every aspect of the account opening approval process for the FI, and that is also capable of interfacing with their respective core systems (regardless of type or protocol) for receiving account opening requests from customers. The account opening platform performs real-time integration with a variety of core systems such that approved new accounts are immediately “boarded” to the FI's core. In an embodiment, the platform is a plug-and-play” architecture such that adding the ability to communicate with new or different cores requires minimal effort. For example, no recoding of basic FMS software is required, but only coding of a plug-in module for a specific FI's core. The account opening platform communicates directly with the prospective customer and places applications that are not approved into a queue such that the application can be completed at any time by direct actions of the customer (e.g., by the customer satisfying a request for further information), or actions of the FI staff. When an application is approved, an account opening message is sent to the FI's core, including all of the required data for opening the account. If no response is received, a self correcting type of error is assumed (such as core system downtime or communication errors), and the application is “retried” at intervals until the condition is corrected and the application can proceed.

Data is required from the applicant and the client in order for the FMS to open account(s) at the client's Core. The FMS collects data from clients by asking clients to fill out a Data Gathering Form (DGF). Any applicant data not collected as part of a standard application can be collected on an Eligibility screen and on an Account Options screen.

The format and specifications of an account opening request message are determined at integration time for each client core. The data available for inclusion in the account opening request message is articulated in Account Opening Data.

Account Opening Data

Data required to open an account on the Core system is collected from two sources: the applicant and the client FI. The applicant provides data to the FMS that describe the applicant(s), the product(s) that are desired, and the funding details. This information is collected from the applicant through various screens in the online application.

The client FI provides to the FMS data that is not specific to an applicant, but that is specific to the client FI or to the products being offered. In an example embodiment, these include products and services offered through the OpenNow and FundNow (ONFN) service of CashEdge, Inc. CashEdge, Inc. is an example of an FMS as the term is used herein. This information is collected from the client FI through the DGF.

Because each DPV and FI have different requirements, it is possible that not all data elements needed for account opening are captured by standard ONFN Application and the standard ONFN DGF. In most cases, the FMS requires a mutual discovery stage in which engineering teams from the FI and the FMS collaborate in determining specific requirements.

FMS Data Gathering Form

The FMS allows clients to configure certain elements of an Account Opening and Funding service so that each FI may customize the service, including the ‘Look and Feel’ of the website and the level of risk to assume on each application, to a format compatible with the FI's corporate website design and risk policy. In order to do this, the FMS asks each new client to fill out a Data Gathering Form (DGF) which allows the Client to specify their preference for each customizable element. Included in the DGF are standard questions whose answers are made available for use within the account opening request.

Recognizing that a particular core system might require specific information on a client FI that is not covered by the standard questions (e.g. specifying the beneficiary for the new accounts), the system has a flexible name-value pair section where the client FI can provide any additional client information that is required by the core but that is not covered elsewhere in the DGF.

Front End UI

The FMS collects information on customers, such as their First Name, Last Name, Social Security Number, etc., in order to approve, fund and open an account for them. This information is collected from the customers as part of the Online Account Opening application process.

In one embodiment, five types of information are available for use within the account opening request message. Each is described below.

Standard Applicant Data

Applicant questions are designed to gather information on the customer, such as First Name, Last Name, Address, and Employment Status, etc.

Each question (in one embodiment, there are 64 standard questions) has a maximum number of characters for freeform questions, specific allowed characters or values, and specific validation conditions. The DGF allows configuration of these questions.

Standard Account Information

Account questions are intended to collect information on the account the applicant (also referred to as a user) would like to open. There are only two questions in this category: the account name(s) of the account(s) customers would like to open and the amount they would like to deposit in it. An applicant can apply for multiple in a single application.

Information need to open the account at the FI, such as account type, product code, etc., are gathered from the client via the DGF.

Standard Funding Details

Funding details are needed from the customer in order for the FMS to fund the new account. The following is an example listing of the questions the FMS would ask the customer:
Funding method (whether the customer would like to fund new account by sending in check or if they rather funding electronically);
Funding account type (if funding electronically);
ABA number (if funding electronically);
Account number (if funding electronically);
Was the account opened more than 12 months? (if funding electronically);
If not, when was it opened? (if funding electronically); and
Online Credentials (user name and Password) if user elected to select use Real Time Verification to verify account ownership. In an embodiment, the FMS collects this data from the customer, but does not retain the data internally or send this data to the FI.

Account Option Questions

The FMS enables clients to customize the Online Account Opening service by allowing clients to gather more data on their customers thru the Account Options section of an Online application form. Clients could add as many additional questions as they want here and these questions could be specific to the type of applicant (e.g. primary or secondary) applicant and/or to the products on the application (e.g. this question is only relevant for Free Checking and Everyday Checking). FIs also dictate the acceptable format of the answers, either freeform or dropdown.

An FI can specify their Account Option Questions via the DGF. Answers to these questions are then available for inclusion in the account opening request message.

Eligibility Questions

The Eligibility section of the application form is designed for client FIs that require their applicants to have certain qualifications. Clients may ask any number of eligibility questions. FIs also dictate the acceptable format of the answers, either freeform or dropdown.

FIs can specify their Eligibility Questions via the DGF. Answers to these questions are available for inclusion in the account opening request message.

Account Opening Request

In an embodiment, account(s) are ready to be opened at the client core when the following milestones are met: Combined Decision, Signature Card, Funding Account, Eligibility, and Destination Account Number. Once the status is “Ready to Open”, the FMS gathers all the data on the application/applicant and sends the data as an Open Account Request via an account opening request message to the FI's core. As used herein, “account” can infer one or more accounts requested to be opened.

The following is a list of details for meeting Account Opening milestones according to an embodiment:
The Combined Decision must be approved;
Either a physical signature card was received or an e-signature was provided online;
The funding account must be verified if funding electronically or a check must have been received, unless the client FI requests that accounts be opened regardless of the funding account status (via DGF, for example);
If the core system does not provide account numbers during account opening, then account numbers for all products on this application must be assigned prior to sending the account opening request;
If there are eligibility requirements, then the applicant(s) must meet all the eligibility requirements; and
finally, if this is a joint application, the secondary applicant must also meet the requirements 1, 2 and 5. Only one of the two applicants needs to fund, so the other applicant can skip funding.

Instantaneous Account Opening

The FMS opens the account instantaneously if the application status is changed to Ready to Open while the customer is online.

The following are entry points to instantaneous account opening according to an embodiment:
A customer applying for an individual application meets all the above milestone criteria within the current online session;
A returning customer (including returning for Trial Deposit verification) meets all the above milestones in the current online session; and
Two customers applying for a joint application meet all the above milestone criteria within the current online session.

Offline Account Opening

An application may not meet all the account opening milestones while the customer is online. For example, the FI might need to perform a manual review, the applicant may need to submit additional ID documentation or the applicant may need to send in a paper check.

To process these applications, whose milestones may be met while the customer is NOT online, the FMS can set up a CRON job to periodically evaluate the readiness of each application. Similar to instantaneous account opening, once an application status is changed to Ready to Open, the FMA gathers all the data on the application/applicant and sends the application/applicant via an XML pipeline to open the account real-time at the FI's core. XML is just one example of a language used in one embodiment, but any other applicable languages could also be used.

The FMS also determines the frequency of each CRON job. As an example, a CRON job may run every two hours.

Destination Account Number Assignment Milestone

A destination account number assignment may or may not be a milestone to open an account as the number could be assigned as part of the process to open the account at the core. This is dependent on how an FI handles the assignment of account numbers. In an embodiment, there are three ways in which a destination account number could be assigned to a new account:
The FI CSR manually assigns the account number. The account number will become another milestone which the FMS will look for when evaluating the readiness of an application. The account will be opened after all the account numbers are assigned;
The FMS sends the application to the FI core, which would open the new account, assign the account numbers and pass the number back to the FMS. In this scenario, Destination account number will not be a milestone to open the account. The account number is assigned by the call initiated by the FMS to the FI core;
The FI uses an account number book offered by the FMS, and the FMS automatically assigns an account number from the book when all other required milestones are satisfied. The account number will become another milestone which the FMS will look for when evaluating the readiness of an application. There are two ways to set up an account number book:
   the FI puts in a range of numbers which the FMS would use to assign account number to. Example: 1001-1100 (the range can have a prefix or a suffix); or
   alternatively, an arbitrary list of account numbers can be provided.

The FMS, in an embodiment, does not use an account number algorithm to assign an account number. The account number becomes another milestone which the FMS looks for when evaluating the readiness of an application. The account will be opened after the account number is assigned.

The destination account number assignment milestone is considered complete only when all new accounts requested were assigned an account number. If there are one or more new accounts pending new account number, then Destination Account Number status remains pending.

If the account number is not a milestone, but part of the account opening request, then all account numbers must be assigned in order for the account opening request to be considered as successful. If any account numbers are missing, then the application would be put into an account opening error queue. The FI customer service representative (CSR) would need to manually correct this error in most embodiments.

Expanding Destination Account Numbers

In an embodiment, the FMS tracks two types of numbers for the Destination Account Number Milestone: ABA Number (RTN) and Destination Account Number, which is the Automated Clearing House (ACH) Account Number. Two more fields may be included in an embodiment: Display Account Number and Internal Account Number. In an embodiment, for each product there is an ABA Number, an ABA Account Number, a Display Account Number, and an Internal Account Number.

In an embodiment, the ABA number and ACH Account Number are required fields. All products must have an ABA number and an ACH Account Number in order for the FMS to consider the Destination Account Number milestone as Assigned.

It is also possible for an FI to provide some of the account numbers, such as Display Account Number, as part of an Account Opening Response file, but the ACH Account Number might still be missing (this might vary from FI to FI, depending on the capability of the FI DPV).

In this situation, the FMS can place the application into ‘Opened but Pending’ Application Status and Destination Account Number status of ‘Unassigned’. The FI CSR can manually input the ACH Account Number, and change the Application Status and Destination Account Status to Opened and Assigned respectively.

Funding Account Milestone

Different clients might have different standards for when they consider an account as ready to be opened. In most cases, a client might request that the FMS verify the ownership of a funding account before opening an account. In other situations, a client might be ready to open an account as soon as the Combined Decision, Signature Card, and Eligibility milestones are satisfied.

Funding Account validation, in an embodiment, is a setting in DGF by which a client can determine whether they want to wait for this milestone to be met before the FMS opens the account. If the client selects ‘Yes’, then a funding account must be verified before the FMS considers an account ready to be opened. If client selects ‘No’, then funding account verification does not have to be completed in order for an application to become Ready to Open.

Account Opening Request Message Format

The FMS and the core system provider work together to create a mutually agreed upon Schema. The layout, nodes, and attributions of each of the nodes, etc., are agreed to by both parties beforehand. Similarly, both parties agree to the account/application request message and the response message.

Once the message is sent, a timer checks to see whether or not a response was received within the time window (each FI could configure the length of time, e.g. 10 seconds). If a response is not received within this time window, the request is assumed to be unsuccessful and is retried at the next Cron job. In the scenario where the customer is on online while the FMS is attempting to open the account, the customer will be brought to a Welcome page with NO account numbers.

Presenting New Account Numbers—Welcome Page

In an embodiment, the FMS provides an Account Opening service including a Front End UI with a ‘Welcome’ screen for the case of immediate account opening. Normally, the last screen of the Account Opening service is the Application Summary screen. If the application is in ready to open status at the end of the online session, the Application Summary screen is replaced with the Welcome screen. The Welcome screen displays the new account number(s) and the confirmation number to the customer if available. The content on this Welcome screen is customizable by the FI.

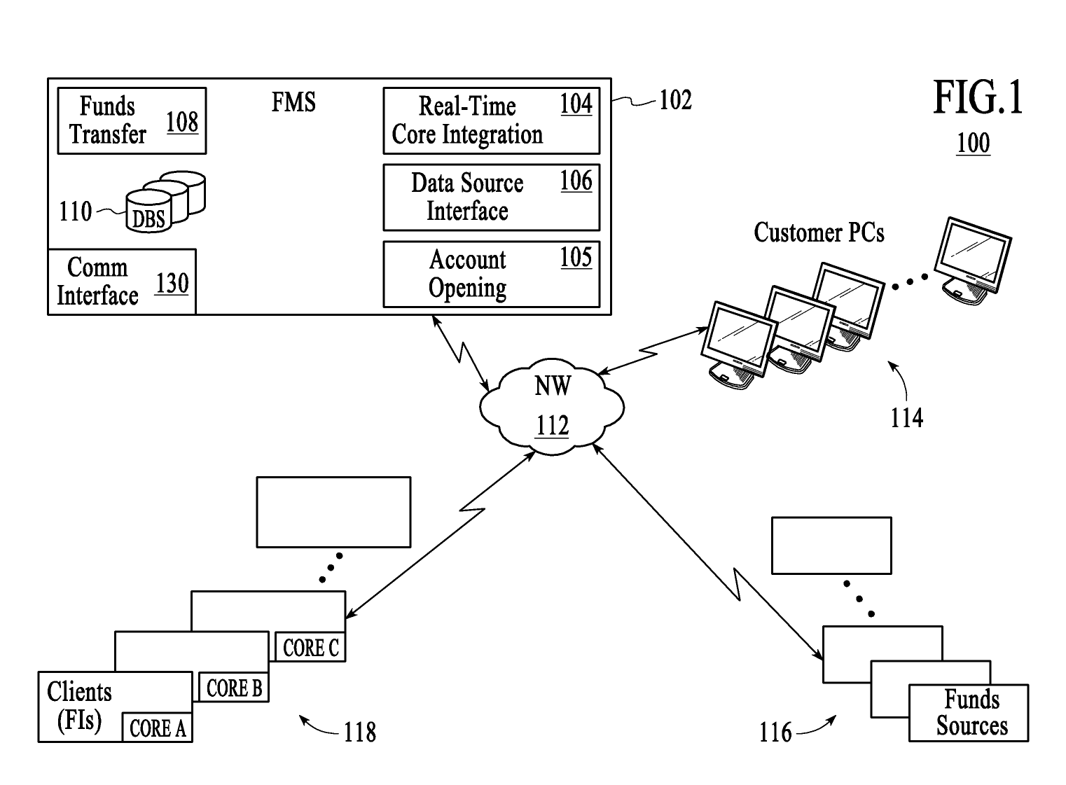

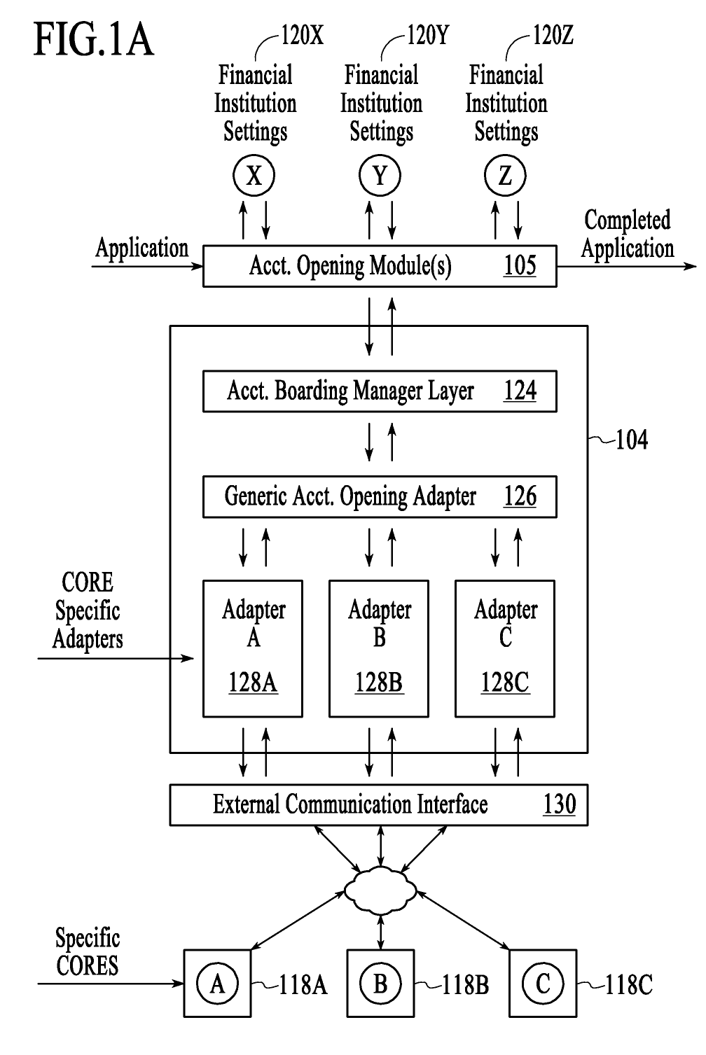

FIG. 1 is a block diagram of a financial system 100. Financial system 100 includes a financial management system (FMS) 102 that provides an account opening platform for multiple financial institution (FI) clients 118 via a network 112. Network 112 includes the Internet, a local area network (LAN), a wide area network (WAN), or any other network that can communicate electronic data securely and efficiently.

The FMS 102 includes a funds transfer module (hardware and software) 108, a data source interface module 106, databases 110 and a real-time core (RTC) integration module 104. As further described below, the FMS 102 provides an interface to customers 114 (for example prospective or current account holders of clients 118) through which customers 114 may communicate with FMS 102 to apply to open accounts with clients 118. FMS 102 completes the data gathering process and approval process as preferred by a specific client 118. Interface module 106 communicates with multiple data sources, for example to verify user identity and gather other data used to determine whether to approve an account request. Data source include Equifax, various financial institutions, etc.

Funds transfer module 108 provides the capability to immediately fund approved new accounts from customer-specified funds sources 116. Funds sources 116 may be the same as clients 118, for example when an existing customer of a client 118 opens a new (additional) account and wishes to fund the new account using an existing account at the same client 118.

FIG. 1A is a block diagram of a RTC integration module 104 of an embodiment. The RTC integration module 104 is a “plug-and play” model that facilitates the integration of the FMS with new/additional cores, such as client cores 118A, 118B and 118C. The plug-and-play model also allows for configuration or reconfiguration of settings or preferences for a client core that is already integrated.

Client cores 118 communicate through 130 with respective core-specific adapters 128A, 128B and 128C. Adapters 128 translate requests from generic account opening adapter 126 into a format required by cores 118.

The core-specific adapters 128 communicate with a generic account opening adapter 126. In turn the adapter 126 communicates with an account boarding manager layer 124. Account opening module(s) 105 communicate with the account boarding manager layer 124. Account boarding manager layer 124 collects the application data to be boarded from the databases 110. Account boarding manager layer 124 further formats the data into a generic format, receives and formats the responses received from the underlying layers (126 and beyond) to a common format, and stores them in the databases 110 (see FIG. 1). Generic account opening adapter 126 invokes the appropriate adapter (128A, 128B, 128C, etc.) based on the configuration of the FI, manages multiple instances of the adapters (e.g., based on the size of the communication load and speed of the network), collects the communications status and responses from the individual adapters, and provides them back to the account boarding manager layer 124. The account opening module(s) 105 receive applications input by users and perform account opening as generally described with reference to the flow diagrams below. Completed applications are output by the account opening module(s) 105. As further described below, the account opening module(s) 105 also communicates information to the account boarding manager layer 124, which can affect real-time boarding of the information to the respective client cores 118.

In an embodiment, specific FI's many change FI setting 120X, 120Y or 120Z by simply providing an input to the account opening module(s) 105 via a software switch mechanism. For example, as described further below, different FIs may choose different milestones to be met before an account can be opened. This preference can be configured using the FI settings 120.

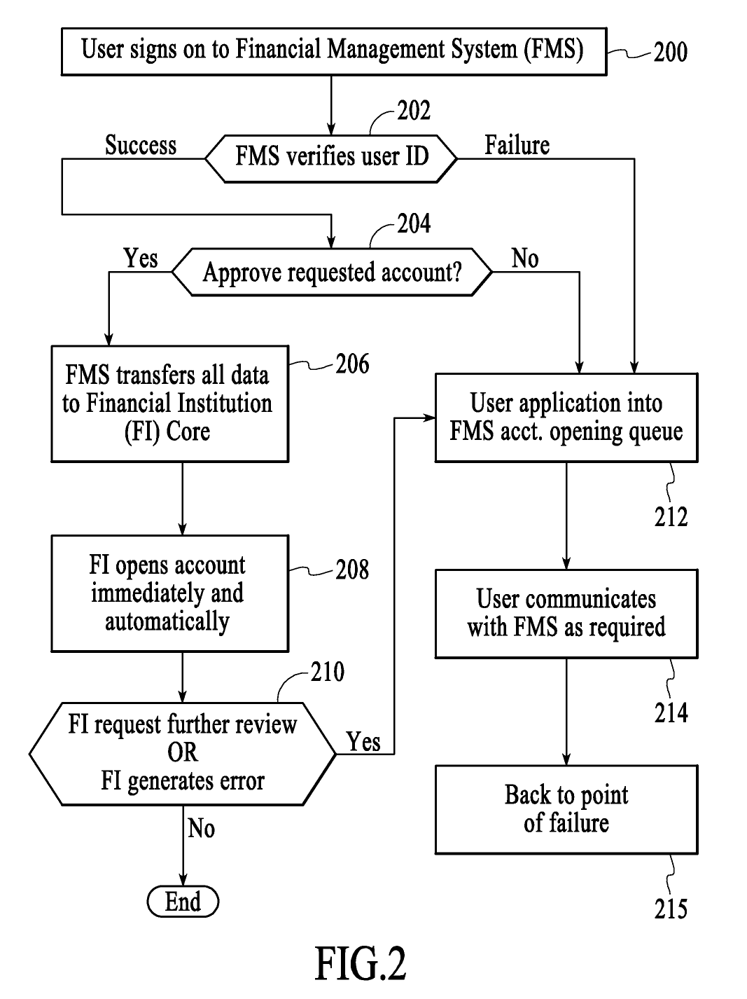

FIG. 2 is a flow diagram of an online account opening process according to an embodiment including real-time core integration. A user (also referred to as a customer herein) signs on to the FMS at 200. In an embodiment, the FMS could provide a web site that is branded to appear as a web site for the FMS, or as a web site for one or more FIs. The FMS verifies the user's identification (ID) at 202. In some cases a user may present some valid information, yet the user is not the person they present themselves as. If the user is not the person they present themselves as, user ID fails and the user application to open an account is placed into an account opening queue provided by the FMS at 212, or the application can be declined. The user can then communicate with the FI at the user's convenience to supply any deficiencies or correct any errors that caused the application to be placed in the account opening queue. As soon as any outstanding requirements are satisfied, the process picks up again at the original point of failure, as shown at 215.

If the user ID was successful, the particular account requested by the user (or the particular financial product, which could include a line of credit, or any other product offered by an FI) is approved at 204. Approval of a requested account at 204 includes the FMS determining that the user satisfies FI configurable milestones for opening a requested financial account. The FMS uses criteria as dictated by the FI for the particular account or financial product. If the requested account is not approved for any reason, the user application is placed in the account opening queue by the FMS at 212. The user then communicates with the FI as required at 214 to resolve the issues that caused the requested account not to be approved. As soon as the user is able to resolve any issue by communicating with the FI, the application returns to the point of failure, as shown at 215.

If the requested account is approved at 204, the FMS transfers all of the relevant user data and account data in real time to the client FI's core at 206. This effectively “boards” the new account at the client core. As further described below, such real-time integration is possible because the FMS is a platform capable of interfacing seamlessly with many different cores. When the account is boarded, the FI immediately opens the new account, including assigning account numbers and any relevant rules or limitation, etc. In some cases the FI may automatically generate and error as shown at 210. The circumstances under which either of these events may occur are configurable according to the desired policies of the particular FI. If there are no requests for further review or errors, the account opening process is at an end. If there is a request for further review of an error, the application is placed into the FMS account opening queue at 212. The user may communicate directly with the FI as required (at 214) to resolve any issues; or the issues may be resolved by internal review. Once outstanding issues are resolved, the process returns to the point of failure as shown at 215. The approval process thus is dependent on the user or customer, who has the ability to make the process move forward again after some failure to meet an approval milestone. This is in contrast to current systems and methods in which an employee at the FI must receive any data necessary to resolve outstanding issues, and then manually restart the application process.

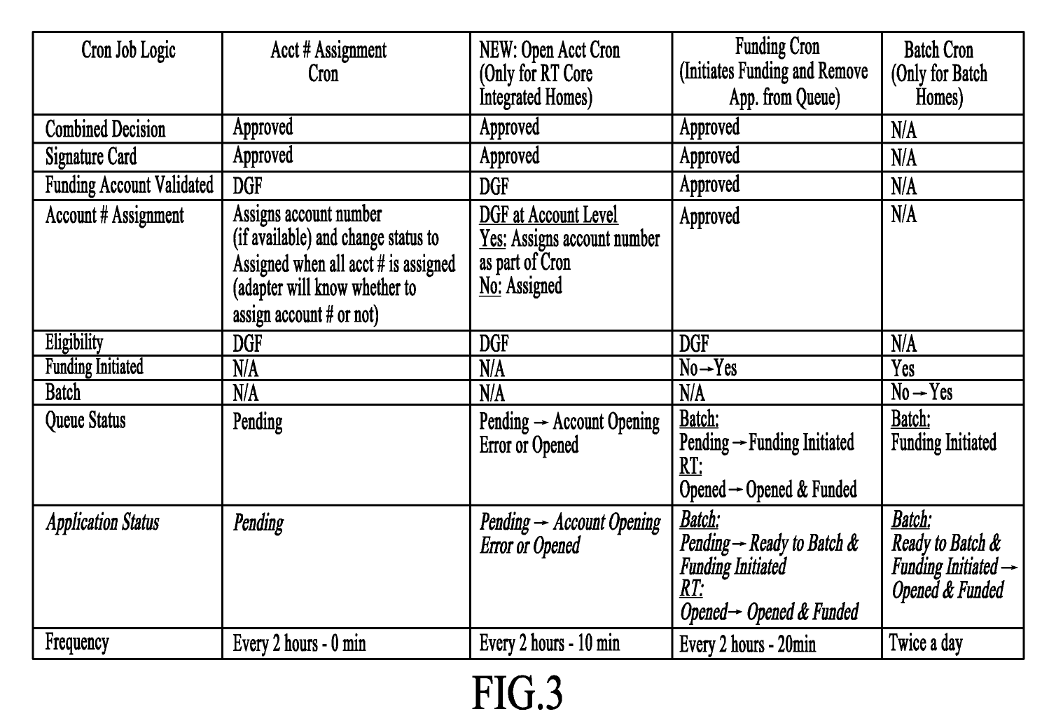

FIG. 3 is a diagram illustrating an account opening request flow according to an embodiment. Various cron jobs are run under different circumstances by the FMS, as shown in FIG. 3. With reference to FIG. 3, there are three different ways in which account numbers for account(s) within an application could be assigned according to one embodiment: Manual Assignment, Automated Assignment by means of Account Number Book and Automated Assignment by means of Open Account Response Message.

The second column of the table in FIG. 3 outlines the various requirements that need to be satisfied before the Automated Account Assignment cron would start. Referring to the first (left column, the items “Combined Decision”, Signature Card”, Funding Account Validation”, Account Number Assignment”, and “Eligibility” are milestones that must be met before an account is opened. The milestones can be configured by the client or the FMS to determine which milestones must be met and which need not be met before an account is opened. The milestones can be configured by the client communicating its preferences to the FMS, which then configures software switches (see FIG. 1A and description). This configuration can occur either during initial installation of the client (including an adapter 128 and FI settings 120), or at some later time. The client may also alter these preferences through a UI according to an embodiment.

Once these requirements are met, this process (Acct # Assignment Cron) will automatically assign account numbers to all products associated with this application. In an embodiment, there are four types of account numbers for each product: ABA Number, ABA Account Number, Display Account Number, and Internal Account Number. ACH Account Number is a required field. All products must have an ACH Account Number in order for the FMS to consider the Destination Account Number milestone as Assigned.

This process is the first of the four cron jobs to run. For example, it may run every two hours starting at 1:30 am ET. Once all accounts for an applicant have account numbers, the Account Number Assignment milestone changes to Account Numbers Assigned.

An FI customer service representative (CSR) can assign an account number to account(s) for an application anytime when the application is in Pending status. This is a manual process supported by the FMS.

For example, the Combined Decision, Signature Card Milestones of an application are Approved. The Funding Account is validated (required by the FI according to DGF) and the Eligibility Milestone is pending (which is not required by the FI according to DGF). The Queue and Application statuses are both in Pending. The FMS then initiates the Account number assignment cron.

An FI can setup the FMS platform interface to automatically assign account numbers from a book of reserved accounts numbers. The FI maintains the available accounts numbers through the Manage Account Books module in an application provided by the FMS. An example of such an application is “Compass” provided by CashEdge, Inc.

Account books support the following features:
Products can share a book (e.g. all checking account products can pull from the same book)
Products can have different books (e.g. checking accounts can pull from one book, while savings accounts pull from a different book)
Account numbers can be added in bulk as a range with a static prefix and/or suffix.
Account numbers can be added in bulk as an arbitrary list (one on each line)
Accounts numbers in a book can be edited (including removed and added)
Each book will specify the ABA Routing Number to use for funding and the ABA type.
When account numbers are running low, emails will warn the staff at the FI.
An account number can be given to the account(s), but the funding can be made to a fixed account number (e.g. For a CD, we can give an account number to the applicant, but the finding for all CDs for all customers will be to a fixed account FI “pool” account).
Account number used for funding can have a prefix. (e.g. if the account number given to the account(s) is XXXXXXXXX, then the account number used to fund the account(s) can be PPPPXXXXXXXXX, where PPPP is a prefix that is shared for all account(s) tied to this book.)

In the scenario where an account number is assigned by means of Open Account Response message, the FMS could ignore the Destination Account Number Milestone and proceed to open the account.

Once all these requirements are met, the FMS generates an Open Account Request message and sends it immediately to the FI Core. For example, the Combined Decision, Signature Card Milestones of an application are Approved. The Funding Account is not validated (not required by the FI according to DGF) and the Eligibility Milestone is empty as this FI does not have Eligibility requirements. The Queue and Application statuses are both in Pending. The FMS sends an Open Account Request message.

This process would be the second of the four cron jobs to run. For example, it may run every two hours starting at 1:40 am ET.

When the account numbers are being assigned as part of the account opening request, the FMS opens account(s) at the FI Core by sending an Open Account Request message, and the FI replies with an Open Account Response message. Within the body of the response message are the account numbers of the account(s) being opened. It is possible for a FI to provide some of the account numbers, such as Display Account Number, as part of the Account Opening Response file, but the ACH Account Number might still be missing (this might vary from FI to FI, depending on the capability of their DPVs). In this situation, the FMS can place the application into ‘Opened but Pending’ Application Status and Destination Account Number status of ‘Unassigned’. The FI CSR must manually input the ACH Account Number, and change the Application Status and Destination Account Status to Opened and Assigned respectively.

The ACH Account Number is always a required field for all Account Boarding Responses. In an embodiment, there is a configurable setting in the DGF that asks if the FI wishes the FMS to copy the ACH Account Number to the Displayed Account Number and Internal Account Number. If the answer is yes, then the FMS copies the account number over to the other two fields. The account opening request is successful when all the ACH account numbers are assigned.

In response to the Open Account Request message, the FI Core sends an Open Account Response message. The message would indicate whether the attempt was successful or not. If successful, the Application and Queue status would change to Opened. If not successful, then the Application and Queue status would change to Account Opening Error.

The fourth column of FIG. 3 indicates the various requirements that need to be met before the FMS runs the Funding Cron. Combined Decision and Signature Card Milestones have to be Approved, Funding Account must be validated, and Destination Account Number must be Assigned. For Batch FIs, the Queue and Application Statuses must be Pending. And for FIs with real-time core integration, both statuses have to be Opened.

In terms of Eligibility, this is a DGF setting in which the FI would decide whether or not Eligibility Milestone needs to be Approved before the FMS funds the new account(s). Once all these requirements are met, the FMS would ‘release funding’. A Funding Initiated flag would change from No to Yes. Once funding is initiated, the Application and Queue statuses for Batch FI would change to Funding Initiated and Ready to Batch and Funding Initiated respectively. Application and Queue statuses for FIs with real-time core integration would both change to Opened and Funded. This process is the third of the four cron jobs to run. For example, it can run every two hours starting at 1:50 am ET.

Once accounts are ready to be funded, the transaction is “released”, so that it can be picked up by the next debit ACH process. For example, an FMS may run four debit processes daily.

Based on the FI's core requirements, a batch file might take the place of real-time core integration. The last column of FIG. 3 indicates the various requirements that need to be met before an application is to be batched. The Funding Flag must be set to Yes, the Queue status must be Funding Initiated and the Application Status must be Ready to Batch and Funding Initiated.

Once the Application Status is Ready to Batch, this process will add this applicant and his account(s) to the batch file. As each account is added to the batch file, it will be marked as “opened”.

If all accounts on an applicant are marked “opened”, then the Application Status will be Opened and Funded. This process runs twice a day. For example, the files may be generated at 2:10 am and 10:50 am PT. The files are sent at 3:10 am and 11:10 am PT. Batch files are not applicable for standalone FN homes.

To prevent applications from staying in the pending state forever, the Withdraw Cron changes the status of applications in Not Submitted/Pending status to Withdrawn if the application is in a pending state for more than X days (X is configurable by partner).

Below are scenarios of when an application would be withdrawn:
1. ‘Pending’ applications will be withdrawn if the ‘Application Submitted’ date is more than X days;
2. Applications in ‘Not Submitted’ status will be withdrawn if the ‘Application Created’ date is more than X days; and
3. If a ‘Pending’ application is re-activated, then it is withdrawn if the ‘Re-activated Date’s is more than X days.

Applicants would not be able to retrieve a withdrawn application using the following options: 1. Sign in as a secondary applicant for the first time, 2. verify trial deposit, or 3. returning to a pending application. Applicants could only retrieve a withdraw application to view the application summary screen. The withdrawal process can run once a day, for example.

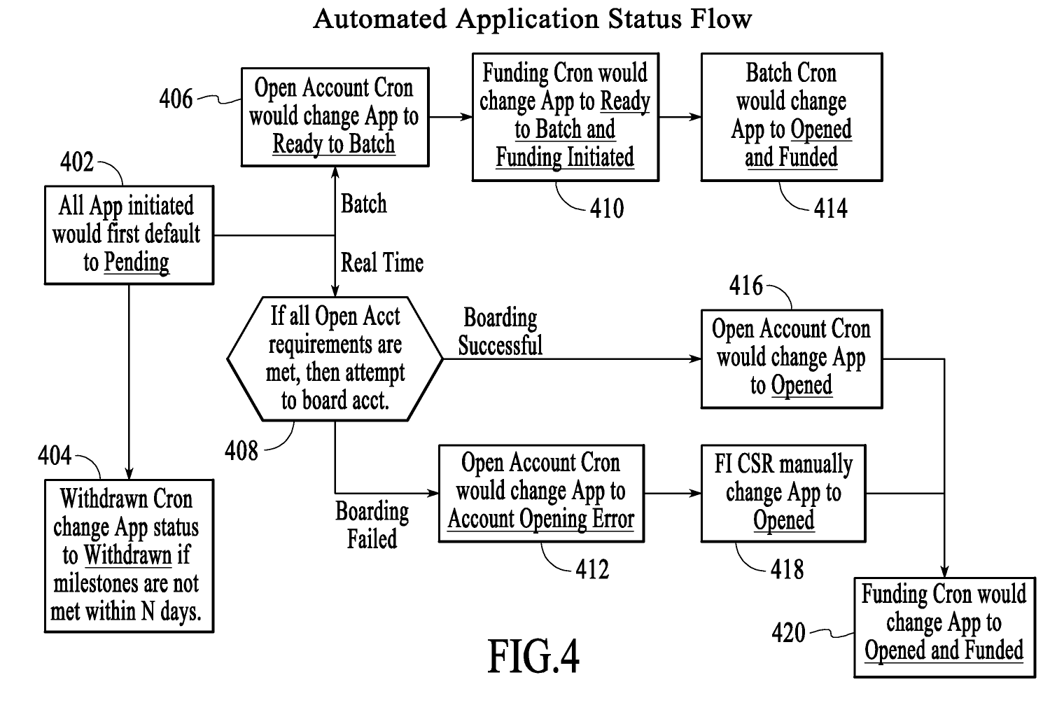

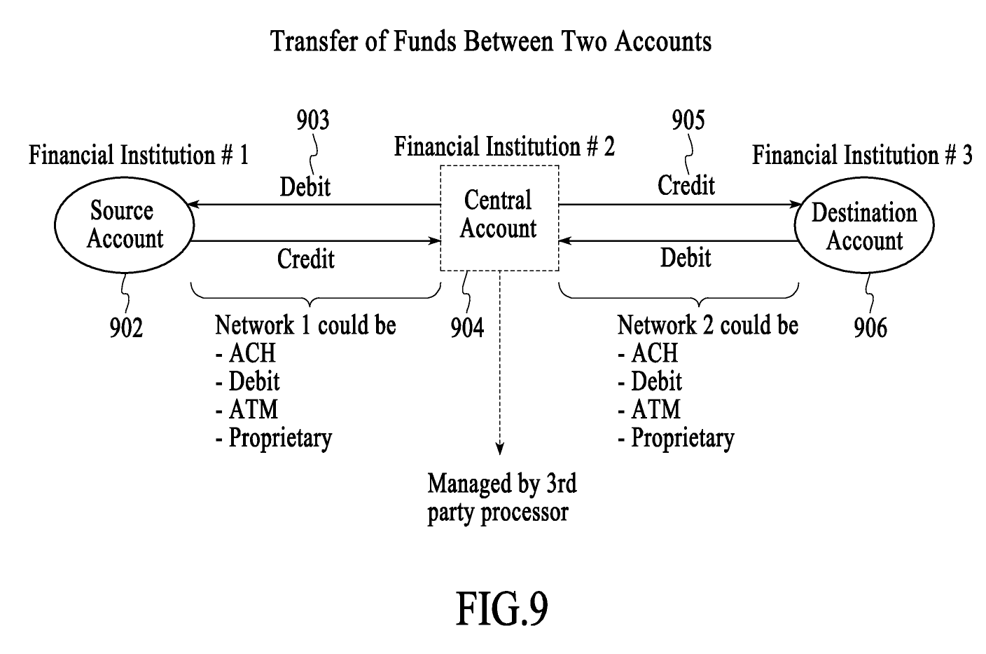

FIG. 4 is a flow diagram illustrating an automated account opening application flow according to an embodiment. As shown at 402, all applications for account opening are initially placed on a default status of “Pending”. A Withdrawn cron changes this application status to “Withdrawn” if the milestones for the application are not met within a predetermined number of days. The FI may be using a batch process to upload information for accounts that need to be opened. The information from this application will then be batched with other applications to be processed at some predetermined time. Alternatively, the FI can be using a real-time integration so that the new accounts are immediately opened, In the case of a batch integration process, an Open Account cron changes the status of the application to “ready to batch” at 406 if all milestones are met. A Funding cron then changes the application status to “ready to batch and funding initiated” at 410. A Funding may entail making a transfer of funds from an existing account owned by the applicant. If this is the case, funds are transferred by the FMS as described further with reference to FIG. 9. When funding is complete, a Batch cron adds the data from this application to the next batch file so that the new accounts can be opened and then changes the application status to open and funded at 414.

If the FI is using a real-time integration to its core, the FMS determines whether all of the account opening requirements (as specified by the FI) are met at 408. This determination involves the FMS determining that the applicant has met all of the milestones specified by the FI, including verifying the identity of the applicant, waiting for a signature card, or any other milestones. If all of the account opening requirements are met, the FMS attempts to board the account. Boarding the account means that the FMS initiates a real-time message with the FI core to provide the FI core with all of the information it requires to open (or board) the new account. If the boarding is successful, an Open Account cron changes the application status to “opened” at 416. A Funding cron then changes the application status to “opened and funded” at 420.

When boarding fails, the Open Account cron changes the application status to “account opening error” at 412. A customer service representative (CSR) at the FI can manually change the status of the application to “opened” when the error is resolved at 418. Then, the Funding cron of the FMS changes the application status to “opened and funded” at 420.

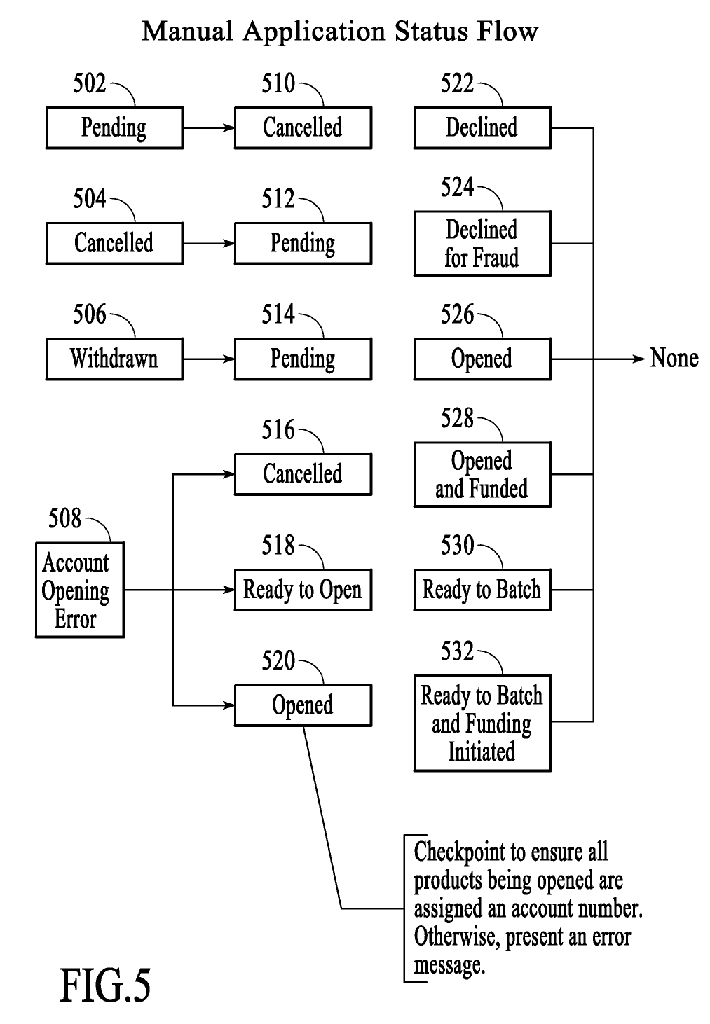

FIG. 5 is a flow diagram illustrating a manual account opening application flow according to an embodiment. This diagram illustrates various statuses that an application can be placed in a manual process in which, for example, a CSR of the FI interacts with an applicant through the FMS account opening application or processes an applicant's application as submitted through the FMS account opening application. An initial status of a submitted application is “pending” as shown in the left column at 502, “cancelled 504, “withdrawn 506” or “account opening error” 508. From “pending” 502 an application may progress to “cancelled” 510. From “cancelled” 504, an application may progress to “pending” 512. From “withdrawn” 506, an application may progress to “pending” 514. From “account opening error” 508, an application may progress to “cancelled” 516, “ready to open” 518, or “opened” 520. At “opened” 520 is a checkpoint to determine that all products being opened are assigned an account number. If an account number is not assigned, an error message is presented.

An application that has an error may be “declined” 522, or “declined for fraud” 524. If an account does not have an error, the account may be “opened” 526, “opened and funded” 528, “ready to batch” 530, or “ready to batch and funding initiated” 532.

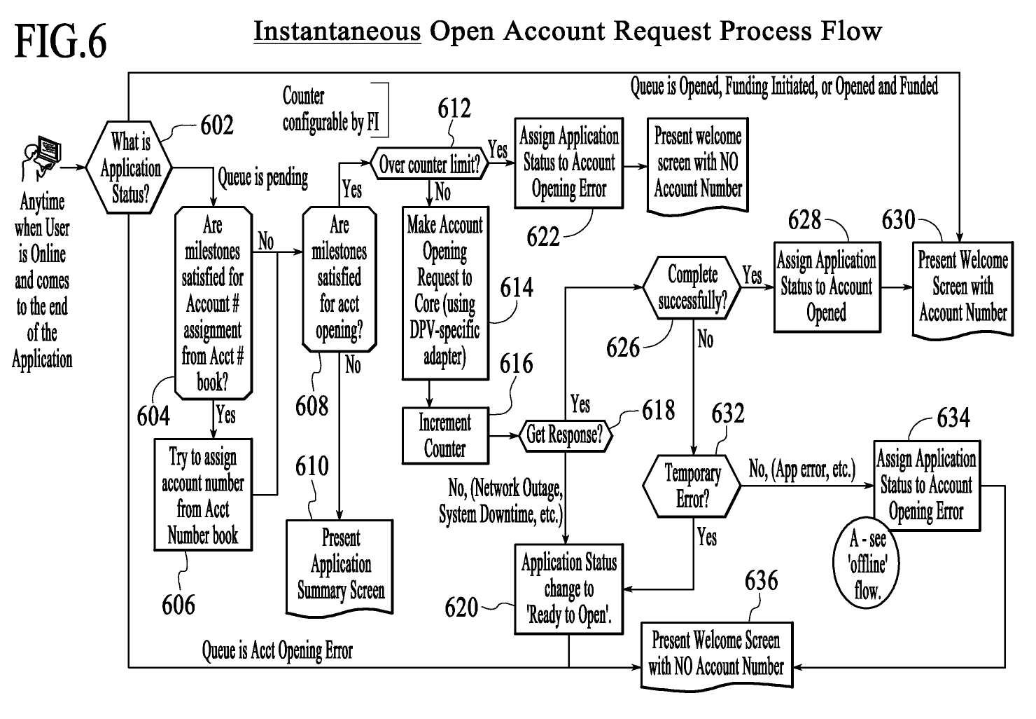

FIG. 6 is a flow diagram illustrating an instantaneous account opening application flow according to an embodiment. As referred to herein, “instantaneous” indicates that the account is opened while user is in-session, onscreen. In this embodiment, a user (also referred to as a customer or applicant) logs in to a web site that is provided by the FMS. An online application is presented to the user. When the user completes the application an application status is determined as shown at 602. The application is queued according to its status. For example, if the application is placed in an “opened” queue, a “funding initiated” queue, or an “opened and funded” queue, the user is presented with a welcome screen that includes an account number for the newly opened account as shown at 630.

If the application is placed in an “account opening error” queue, the user is presented with a welcome screen that does not include an account number, as shown at 636

If the application is placed in a “pending” queue, the FMS determines whether all milestones are satisfied for account number assignment from an account number book, as shown at 604. If the milestones are satisfied, the FMS attempts to assign an account number at 606. If all milestones are not satisfied for account number assignment from an account number book, the FMS determines whether all milestones are satisfied for account opening, as shown at 608. If all milestones are not satisfied for account opening, the user is presented with an application summary screen at 610 which explains outstanding milestones.

If all milestones are satisfied for account opening, the FMS determines whether the requested account process is over a counter limit at 612. The counter limit is configurable by the FI. If the counter limit is exceeded, an application status of “account opening error” is assigned at 622, and the user is presented with a welcome screen that does not include an account number at 624.

If the counter limit is not exceeded, a request is made to open the account at the FI core, for example using a core-specific adapter, at 614. The counter is then incremented at 616. The FMS check for a response from the FI core at 618. If no response is received (for example, because of network outage, system downtime, etc.) the application status is changed to “ready to open” as shown at 620.

If a response is received, and the response indicates successful completion, as shown at 626, the application status becomes “account opened” at 628, and the user is presented with a welcome screen displaying an account number at 630.

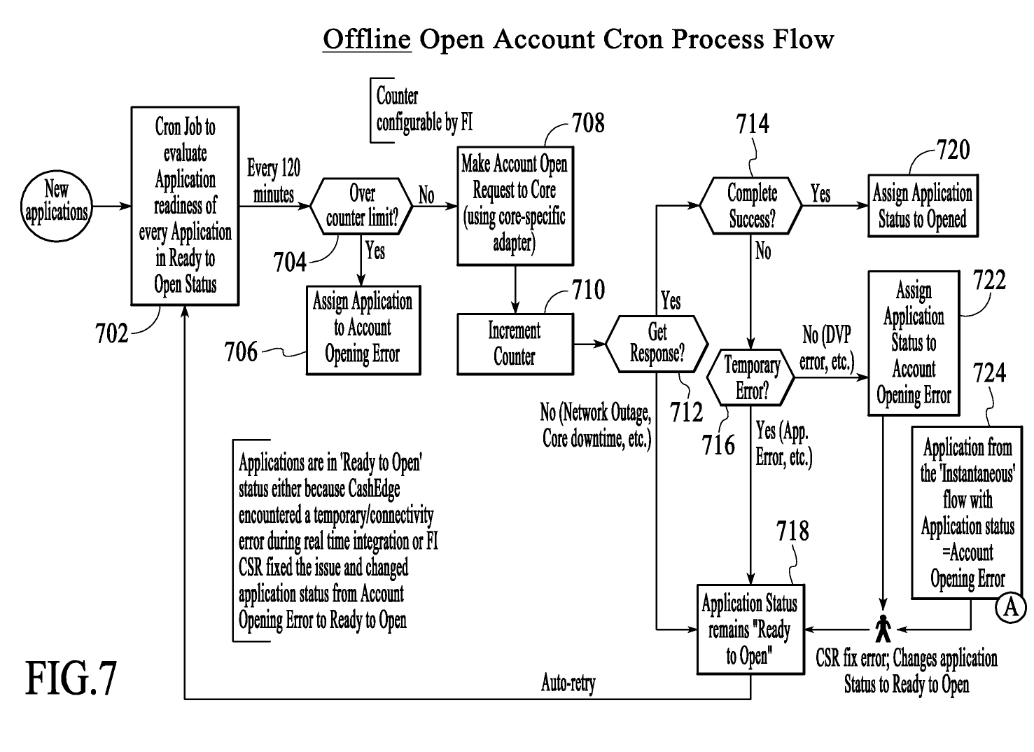

If the response is received, but the application has not completed, the FMS determines whether a temporary error exists at 632. If a temporary error exists, the application status remains “ready to open”, and the user is presented with welcome screen that does not include an account number as shown at 636. If the error is not a temporary error, the application status becomes “account opening error” at 634, and the user is presented with welcome screen that does not include an account number as shown at 636. As further described below with reference to FIG. 7, the applications with “account opening error” status at 634 (see reference note “A”) proceed to another “offline” flow.

FIG. 7 is a flow diagram illustrating an offline “open account” cron process flow according to an embodiment. Each new application is evaluated for readiness by a cron job as shown at 702. In an embodiment, this cron job runs every 120 minutes, but any other intervals could be used. At 704, the FMS determines whether a counter limit has been exceeded at 704. The counter is configurable by the FI. If the counter limit is exceeded, the application status is changed to “account opening error” at 706.

If the counter limit is not exceeded, a request to open the account is made to the core, for example using a Core-specific adapter, as shown at 708. Then the counter is incremented at 710. The FMS determines whether a response has been received from the FI core at 712. If no response is received (for example, because of network outage, system downtime, etc.) the application status s changed to “ready to open” at 718.

If a response is received, and the response indicates successful completion, as shown at 714, the application status becomes “account opened” at 720

If the response is received, but the application has not completed, the FMS determines whether a temporary error exists at 716. If a temporary error exists, the application status becomes “ready to open” at 718. Application are in “ready to open” status, for example, because the FMS encountered a temporary connectivity error during real-time integration, or an FI CSR fixed the issue and changed the status from “account opening error” to “ready to open”. If the error is not a temporary error, the application status becomes “account opening error” at 722. An FI CSR manually fixes the error, allowing the application to assume a “ready to open” status. The application is then automatically retried by the cron job at 702.

Applications that received an “account opening error” status in the flow of FIG. 6 at 634 also enter this offline flow at 724, and are handled by a CSR.

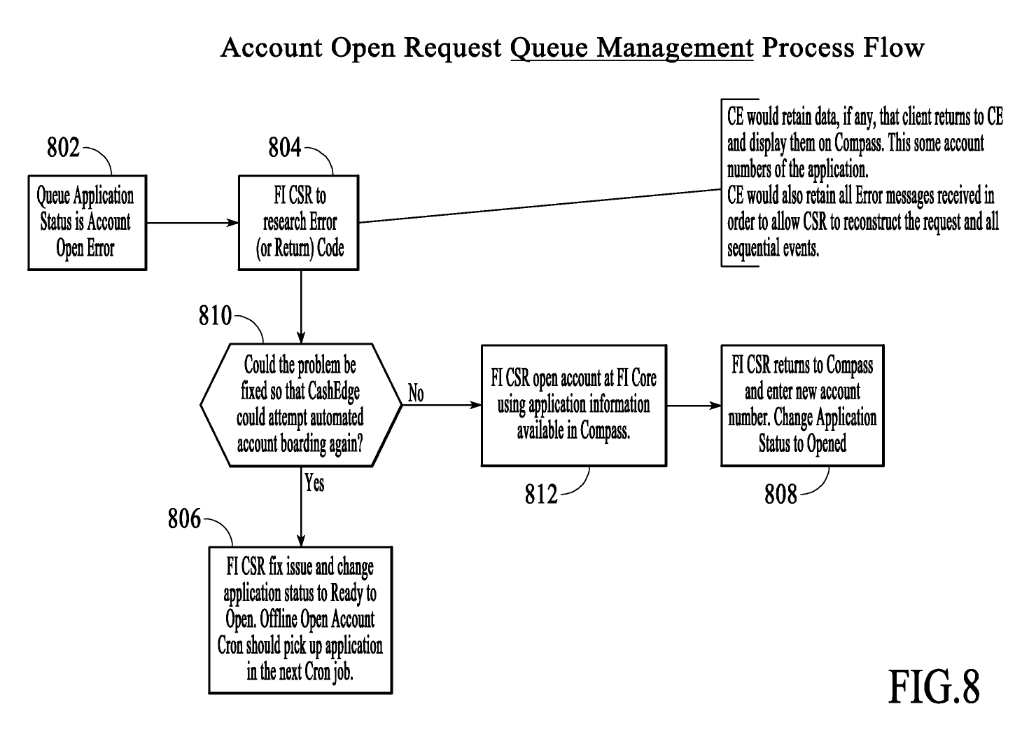

FIG. 8 is a flow diagram illustrating an account opening request queue management process according to an embodiment. At 802, an application is in an “account opening error” status queue. The FI CSR can research the error. The CSR may receive and research an error code, or may research the error and return and error code to the FMS at 804.

In an embodiment, the FMS retains the data, if any, that is returned to the FMS. In addition, the FMS retains al error messages received in order to allow the CSR to reconstruct the initial request and all subsequent events.

At 810 it is determined whether the problem or error can be fixed so that the FMS can re-attempt automated account boarding. If the answer is yes, When the FI CSR has resolved the error, the CSR can open the requested account at the FI core using an FMS supplied application at 806. An example of such an FMS-supplied application is Compass™ available from CashEdge, Inc. The application status changes to “ready to open”. The offline open account cron should then pick up the application for processing in the next cron job.

If the answer at 810 is no, the FI CSR can open the account at the FI core using an FMS supplied application at 812. At 808, the CSR can use Compass to enter the new account number and change the application status to “opened”.

FIG. 9 is a diagram illustrating a funds transfer flow as conducted by an FMS funds transfer module 108 (see FIG. 1) according to an embodiment.

Financial institution #2 is for the benefit of the funds transfer module 108 (FIG. 1), and in an embodiment is managed by a third party processor. In this instance “third party” infers that financial institution #2 is separate and independent from financial institution #1 and financial institution #3. For purposes of this disclosure, the third party processor is the FMS 102. In order to transfer funds from a source account 902 (for example a customer account) to a destination account 906 (such as a newly-opened customer account), the funds transfer module 108 first executes a debit transaction with the source account 902. Then the funds from the first debit transaction are deposited in the central (or intermediate) account 904 in a first credit transaction.

The funds are then withdrawn from the central account 904 in a second debit transaction, and deposited in destination account 906 in a second credit transaction. Financial institutions #1 and #2 have no knowledge of central account 904. This is in contrast to conventional electronic funds transfers in which the financial institution providing the funds and the financial institution receiving the funds must deal directly with each other and have particular information or data about each other in order to complete the transaction. As shown, the debit and credit transactions can be accomplished using any one of various existing networks, including but not limited to an ACH network, a debit network, an ATM network, and any type of proprietary network.

What we claim is:

1. A method of opening a financial account, the method comprising:
a financial management system receiving a request from an applicant to open a financial account at a financial institution, wherein the financial management system is communicatively coupled with a plurality of financial institutions;
the financial management system determining whether the request is approved according to rules of the financial institution;
if the request is not approved, the financial management system placing the request in an account opening queue;
the financial management system receiving further inputs that allow the request to be approved;
if the request is approved, the financial management system transferring data regarding the application and the account to the financial institution core system according to a protocol of the core system; and
the financial institution automatically opening an account in real time in accordance with the request.

2. The method of claim 1, wherein the further input comprises input from the applicant, data obtained from the financial institution, and data obtained from a plurality of data sources.

3. The method of claim 1 further comprising verifying an identity of the applicant.

4. A financial management system, comprising:
a communications interface coupling the financial management system to at least one network;
a data source interface module configurable to communicate with a plurality of data sources via the at least one network;
at least one database configurable to store data comprising data regarding a plurality of financial institutions, data regarding core systems of the plurality of financial institutions, and data regarding customers of the financial institutions, wherein customers comprise existing customers and prospective customers; and
a real-time core integration module configurable to,
transfer data regarding the customer and the account opening request to a core system of the financial institution according to a protocol of the core system;
determine whether there is an error in the account opening request, wherein an error comprises a permanent error and a temporary error
place the application in an account opening queue if there is an error in the account opening request; and
monitor the account opening queue such that,
when the error is corrected, the account opening request is approved, and data regarding the customer and the account opening request is transferred to a core system of the financial institution according to a protocol of the core system; and
the account opening request is withdrawn if the error is not corrected within a predetermined period.

5. The system of claim 4, wherein the financial management system is further configurable to:
receive data from a customer comprising an application to open a financial account at one of the financial institutions; and
determine whether to approve the application based on rules of the financial institution.

6. The system of claim 4, wherein the FMS is configurable to verify an identity of the customer using the data source interface module.

7. A method of opening a financial account at a financial institution, the method comprising:
receiving a request from an applicant to open a financial account at one of a plurality of financial institutions;
determining whether to approve the request based on rules for approving the request, wherein the rules are specific to the financial institution, wherein rules comprise a plurality of milestones that are configurable by the financial institution;
if the request is not approvable, placing the request in a queue;
monitoring the queue to determine whether information has been received to make the request approvable; and
when the request is approvable, transmitting data to a core system of the financial institution to enable real-time opening of an account specified in the request.

8. The method of claim 7, wherein milestones comprise:
identity verification of the applicant;
signature card approval;
funding account verification;
eligibility; and
assignment of financial institution account number.

9. The method of claim 7, wherein the plurality of milestones are met independently of one another.

10. A financial management system, comprising:
a communications interface coupling the financial management system to at least one network;
at least one database configurable to store data comprising,
data regarding financial institutions;
data regarding respective core systems of financial institutions;
data regarding customers of financial institutions, wherein customers comprise prospective customers; and
data regarding customer and account information;
a real-time core integration module configurable to,
maintain plug-and-play adapter modules comprising data specific to core systems of each of the plurality of financial institutions in the format specified by the protocols of the core systems;
perform real-time account opening services for a plurality of financial institutions using a predetermined set of preferences for each of the financial institutions, comprising a set of account opening milestones configurable by each of the financial institutions;
determining that an account is not approved for opening and placing the account in an account opening queue, wherein the account opening queue holds account opening applications from customers of the plurality of financial institutions, and each of the plurality of financial institutions has access to information regarding only their own respective customer applications; and
when information is received allowing approval of a request in the account opening queue, transmitting data to a core system of the respective financial institution such that the respective financial institution can immediately open the requested account, wherein receiving information comprises receiving information input by the applicant.

11. The system of claim 10, further comprising a data source interface module configurable to communicate with a plurality of data sources via the at least one network, and wherein data received from the plurality of data sources is used by the financial management system to verify an identity of the customer.

12. The system of claim 10, further comprising a data source interface module configurable to communicate with a plurality of data sources via the at least one network, and wherein data received from the plurality of data sources is used by the financial management system to verify a risk level of the customer.

13. The system of claim 10, wherein the FMS maintains all stored data in the same format and the data is accessible to client financial institutions via an online graphical user interface (GUI), regardless of the format in which the data was originally received.

14. A method of opening a financial account, the method comprising:
a financial management system receiving a request from an applicant to open a financial account at a financial institution, wherein the financial management system is communicatively coupled with a plurality of financial institutions;
the financial management system determining whether the request is approved according to rules of the financial institution, wherein determining comprises automatically periodically checking a status of the request after receiving the request;
upon encountering an error during determining whether the request is approved,
determining whether the error is a temporary error that will be resolved without manual intervention, or an error that is not temporary and requires manual intervention to be resolved;
if the error is a temporary error, placing the request in a first application opening error queue, and periodically retrying the application at a point at which the error was encountered; and
if the error is not a temporary error, placing the request in a second application opening error queue, wherein the error requires manual intervention to resolve, and reporting the error to the financial institution.

15. The method of claim 14, further comprising the financial management system:
transferring a message to the financial institution when a determination is made that the request is approved; and
if no response is received, placing the application in the first application opening error queue.
